(19) United States
(12) Patent Application Publication
(10) Pub. No.: US 2011/0274518 A1
(43) Pub. Date: Nov. 10, 2011

(54) Methods and Apparatus for Transferring and Laying Elongate Articles at Sea

(76) Inventor: Jean-Baptiste Pose, Aberdeenshire (GB)

(21) Appl. No.: 12/672,928

(22) PCT Filed: Aug. 8, 2008
(86) PCT No.: PCT/GB2008/050688

§ 371 Date: Jul. 11, 2011

(30) Foreign Application Priority Data
Aug. 10, 2007 (GB) 0715527.8

(51) Int. Cl. B65G 67/60; B63B 27/30

(52) U.S. Cl. 414/139.4; 414/803

(57) ABSTRACT

A very long article such as rigid steel pipeline (100) is transferred to a laying vessel (200). The vessel has apparatus (206, 208) for lowering such articles into the sea in a controlled manner. The transfer and laying is conducted in a first step of spooling said article from a source facility (104) onto an intermediate storage reel (12, 102, 102) separate from the laying vessel, and a second step of transferring the article from the intermediate reel to storage (202,203) on the laying vessel. The intermediate reel (102) is supported primarily by its own buoyancy in water, floating adjacent the source facility (104) during said spooling step and floating adjacent the laying vessel (200) during said transferring step. The floating reel may be provided with a buoyant frame (900).

The invention relates to methods and apparatus for transferring pipeline and similar very long articles from a pipeline factory to a pipelay ship. The invention in different embodiments is applicable to the handling of continuous steel pipelines, flexible pipeline cables and umbilicals. “Very long” in this context can be taken to mean over 1000 m in length, potentially several kilometres.

For continuous laying of pipelines at sea, a pipelay vessel is commonly provided with one or more large reels, permanently mounted on the vessel, which on the largest vessels can store 2,000 t or more of pipeline. Before being loaded onto the reels, the pipeline is fabricated by welding together sections of pipe to form the desired length. Although it has been proposed to provide pipeline factories on board a vessel, another method consists in locating the pipeline factory on shore at a ‘spoolbase’ or ‘reelbase’ the vessel must then sail to the spoolbase for (re-)loading with pipeline. The need for transit back and forth between a laying location and the spoolbase to reload the ship represents a major element of the overall cost and duration of the overall pipelay operation.

At a conventional spoolbase, the pipeline is fabricated in straight sections or stalks of about 600 m to 1800 m. A conventional reel lay vessel is then loaded by reeling-on one stalk, performing the joint (‘tie-in’) between the loaded stalk and the next stalk and carrying on reeling. The lengthy operation isn't usually the spooling in itself, but the tie-in operation, which can take up to 6 hours per joint. Therefore, the straight length available on shore is an important factor in the efficiency of the overall combination of lay vessel and spoolbase. The easiest way to increase the stalk length is to increase spoolbase length by extending it towards more land onshore, but land is not always available within the required configuration. Furthermore it increases the cost of the spoolbase and so militates against the provision of a spoolbase close to every lay site.

To improve efficiency, some have proposed a method of reel-to-reel transfer whereby the pipeline is first wound around supplementary reels mounted onshore or on cargo barges. By doing so, all intermediate connections can be realised before the reel ship itself has to be present for loading. The primary example of such a proposal is patent application WO/1998/015763 (McDermott). The technique has been tried only experimentally, so far as the present applicant is aware. Reel-to-reel operation improves utilisation of the pipelay vessel. However the specialised support bearings required for a large reel demand a substantial capital investment in themselves, which again militates against the provision of spoolbases close to every worksite.

The invention aims to provide alternative modes of transporting, transferring and/or laying elongate articles at sea. The invention in one particular aspect aims to achieve the improved vessel efficiency associated with reel-to-reel transfer, but without the same increase in the capital cost of the spoolbase.

The invention in a first aspect provides a method of transferring a very long article to a laying vessel, the laying vessel having apparatus for lowering such articles into the sea in a controlled manner, the method including a first step of spooling said article from a source facility onto an intermediate storage reel separate from the laying vessel, and a second step of transferring the article from the intermediate reel to storage on the laying vessel, the storage on the vessel being for presenting said article to said lowering apparatus during a laying step subsequent to the transferring step, wherein the intermediate reel is supported primarily by its own buoyancy in water, floating adjacent the source facility during said spooling step and floating adjacent the laying vessel during said transferring step.

The article may comprise a length of rigid pipeline, the storage on the vessel in that case comprising typically a reel.

The article may alternatively comprise flexible pipeline or other flexible article such as cable or umbilical cable.

Particularly for flexible articles, the storage on the vessel may comprise a hold space into which the elongate article is coiled during transfer. Said hold space may include a receptacle to rotate as the article is transferred from said intermediate reel into said coil

The invention provides a method of transferring a length of pipeline from a storage area on land to a storage reel on a pipe-laying vessel, the method including a first step of spooling a length of pipeline from a source facility onto an intermediate storage reel separate from the vessel, and a second step of transferring the pipeline from the intermediate reel to the reel on the vessel, wherein the intermediate reel is supported primarily by its own buoyancy in water, floating adjacent the source facility during said spooling step and floating adjacent the vessel during said transferring step.

The spooling step may be performed without the laying vessel being present, that is, while the vessel is operating, or in transit to the spoolbase. The pipeline or other article can thus be wound onto the floating reel from a jetty before the vessel comes in, achieving the efficient use of the vessel associated with the known reel-to-reel transfer technique. By using a self-supported floating reel, the invention enhances the economics of the reel-to-reel transfer by avoiding the need for the structure and bearings able to carry its load. As already stated above, the invention in its broadest aspects encompasses more than reel-to-reel transfer of rigid pipe.

The pipeline factory will typically be located onshore by a quay, although the method could in principle be performed using a pipeline factory located on a barge. References to the ‘jetty’, ‘quay’ or ‘quayside’ are thus to be interpreted as encompassing a floating barge or pontoon carrying or otherwise associated with the pipeline factory.

The method may include a step of moving the floating reel in its laden state between said spooling and transferring steps.

Said moving step may comprise re-orienting the reel for transfer to the vessel, while occupying substantially the same position in the water.

The moving step may include translating the floating reel bodily to a different location for said transferring step. It will be seen that the floating reel provides additional flexibility in the layout and operations of the spoolbase. When the vessel comes in, the reel can be towed to the vessel alongside a quay and the reel-to-reel transfer may commence. With such arrangement it becomes possible to load pipeline and other very long articles simultaneously with servicing and other loading of the vessel alongside any quay.

In further embodiments, the moving step may include towing the floating reel in open sea to the location of the laying vessel. In one embodiment, the floating reel is provided with non-planar end surfaces to facilitate passage through the water in an axial direction. Two or more floating reels may be coupled together for towing as a unit.

Various arrangements and designs of the floating reel may be envisaged, some including a drive system on-board the reel, and some relying on drive systems remaining onshore or on the reel ship. The drive mechanism used for the spooling and transfer steps may be the same one, a different one of the same type, or it may be quite different in form.

Said spooling step may include applying a torque via a spooling drive mechanism so as to turn the floating reel and control the spooling on of said pipeline.

A source of motive power for said spooling drive mechanism may be located on the quay, the drive mechanism including means for coupling the power source to the floating reel.

Alternatively, source of motive power for said spooling drive mechanism may be carried on a frame having its own buoyancy and floating with the reel while permitting the reel to rotate within the frame, the drive mechanism including means for coupling the power source to the floating reel.

The coupling means in any of the above spooling drive mechanisms may comprise a combination of at least one tension element and at least one bracing element acting at different heights on the wheel so as to apply torque while holding the floating reel at a distance from the quayside.

Where the source of motive power for the spooling drive mechanism and the pipeline factory are both located at the same side of the reel, the bracing element(s) will generally be arranged to bear on the reel at a height intermediate between the height at which the article is taken onto the reel and the height at which said tensioning element(s) acts.

The tension elements may comprise tendons (such as wires or chains) wound around a part of the floating reel distinct from a part where the article is wound. The tendon may form part of an endless loop driven to cause the floating reel to rotate and wind-on the article. The tendon may alternatively be progressively unwound from the floating reel onto a winch. The bracing elements may be of substantially fixed length, bearing on the floating reel at an axis of rotation.

In a preferred embodiment, pairs of bracing elements and tensioning elements are provided, to act in balance at either side of the floating reel.

Optionally, the spooling step includes removing ballast from the floating reel so as to compensate at least partially for the weight of article carried on the reel.

Said transferring step may include applying a torque via a transfer drive mechanism so as to maintain a predetermined back-tension in the pipeline between the floating reel and vessel, while drawing the article onto the vessel.

A source of motive power for said transfer drive mechanism may be located on the quay, the transfer drive mechanism including means for coupling the power source to the floating reel.

Alternatively, source of motive power for said transfer drive mechanism may be carried on a frame having its own buoyancy and floating with the reel while permitting the reel to rotate within the frame, the transfer drive mechanism including means for coupling the power source to the floating reel.

As a further alternative, a source of motive power for said drive mechanism may be located on said laying vessel, the drive mechanism including means for coupling the power source to the floating reel. This alternative allows the transfer step to be performed remote from the spoolbase, at another quayside or even out at sea, in embodiments which lack a drive mechanism travelling with the reel itself.

The coupling means in any of the above transfer drive mechanisms may comprise a combination of at least one tension element and at least one bracing element, the tension and bracing elements acting at different heights on the reel so as to apply torque while holding the floating reel at a distance from the vessel.

In embodiments with a frame, the bracing elements may comprise limbs of the frame. The bracing elements may act at a hub of the floating reel, via bearings.

Alternatively, the tensioning and bracing elements may extend between a quayside and the floating reel, or between the vessel and the floating reel. In the former case, the vessel must additionally be anchored or otherwise hold station relative to the quayside as part of defining said back tension. In the latter case, the vessel and floating reel can move independently of the quayside, holding station relative to one another only.

The tension elements may comprise tendons (such as wires or chains) wound around a part of the floating reel distinct from a part where the article is wound. The tendon may form part of an endless loop driven to cause the floating reel to rotate and wind-on the article. The tendon may alternatively be progressively unwound from the floating reel onto a winch. The bracing elements may be of substantially fixed length, bearing on the floating reel at an axis of rotation.

In a preferred embodiment, pairs of such bracing elements and tensioning elements are provided, to act in balance at either side of the floating reel.

Optionally, the transferring step includes adding ballast to the floating reel so as to compensate at least partially for the decrease in the weight of pipeline carried on the reel.

The reel may be dimensioned so as to provide at its widest point an incremental buoyancy in excess of 250×10³ kg per metre of immersion, preferably in excess of 300×10³ kg per metre.

In one embodiment, the path of the pipeline in said transferring step is controlled via a device able to guarantee a constant tension within the pipeline all along the transfer as well as correct geometry despite potential relative movements of vessel or jetty and floating reel.

In one embodiment, there are at least as many floating storage reel as reels on the reel ship.

In an embodiment where each reel is provided with a floating frame, two of said frames may be provided with complementary mechanical coupling parts, for rafting them together. The couplings may be for coupling the reels generally side by side with their axial end faces facing one another, or alternatively with their axes parallel and spaced such that an article unwinding from one reel will pass over or under the other.

Further complementary couplings may be provided on a fixed structure such as a quay, and/or on the vessel, for mooring the frame and reel combination using the same mechanical couplings. The or each frame may be provided with complementary male and female mechanical coupling parts at opposite sides thereof.

In an embodiment where the reel is provided with a floating frame, the frame and reel may be coupled by bearings at the axis of rotation. These may be alternative to or additional to bearings on a rim of the reel. The invention still avoids the very costly bearings of the known reel-to-reel transfer proposal, because the bearings need only carry marginal weight and possibly forces generated by the drive mechanisms and tension in the article, which are generally an order of magnitude smaller than the weight of the load and reel out of water.

The frame may comprise a generally rectangular structure having at least three sides, when viewed from above, having at one end a cross-beam structure extending generally parallel to the axis of the reel and outside a winding surface of the reel, and a pair of arms extending generally parallel to a radius of the reel toward the axis of rotation along at two sides of the reel. (‘Side’ in this context refers to the end faces of the reel, in the axial direction.) The rectangular structure may be effectively four-sided, if preferred.

The drive mechanism for spooling and/or transfer may include means for transferring radial forces to the reel via said arms.

Alternatively or in addition, the drive mechanism for spooling and/or transfer may include bracing elements acting between points on said cross-beam structure and circumferential surfaces on said reel.

The frame, if it has buoyancy at an extended radial distance outside the radius of the floating reel, allows drive and control apparatus to be carried and moved from place to place as part of a self-contained floating reel & frame assembly, without the expense of providing a complete barge for supporting the laden reel fully out of the above the water.

The frame, in a case where it has buoyancy at an extended axial distance outside the length of the floating reel, can provide stability against rolling of the reel.

While the transfer operation can be conducted in the sheltered waters at a shorebase, the transfer apparatus may be improved to cope with larger relative movements of both reel and vessel, and the floating reel designed for transoceanic tow. The invention in such an embodiment enables the loading of a reel lay vessel in its field of operation, that is without the need for transit to an onshore base, yet without any need to lift a loaded reel, nor to support it on mechanical bearings.

The article may be welded steel pipeline, the source facility comprising a pipeline factory in which said welded steel pipeline is fabricated from shorter sections of pipe. The pipeline may alternatively be flexible pipeline and the floating reel be a tool to transport the pipeline to another region without requiring the mobilisation of a dedicated flexible pipe carrying or laying vessel. The source facility may be on land or on floating vessel.

The invention further provides an apparatus for use in transferring a very long article such as pre-fabricated pipeline to a laying vessel, the apparatus comprising:

a reel for receiving said article from a source facility and storing it prior to transfer to a vessel, the reel having integral buoyancy sufficient to support itself for rotation about an axis by floating while winding on and subsequently unwinding a load; and

a frame having its own buoyancy, the frame being adapted to float with the reel while permitting the reel to rotate within the frame,

The reel may be adapted for floating with said axis substantially horizontal. This facilitates winding, although in principle a horizontal axis is not essential. The orientation for winding need not be the same as the orientation for transit.

The reel is optionally provided with adjustable buoyancy so as to counter the weight of different quantities of stored pipe during winding or unwinding. The adjustable buoyancy may comprise ballast tanks with inlets for receiving a quantity of water as ballast to reduce buoyancy, the apparatus including one or more pumps for removing said water progressively to increase buoyancy. This adjustable buoyancy can be eliminated if the apparatus is designed to tolerate a significant variation in flotation height.

The apparatus might be adapted for transoceanic tow and profiled accordingly to limit drag and increase transit speed.

The apparatus may further comprise drive means for applying torque to the reel to cause winding and/or to control unwinding of the stored article.

A source of motive power for said spooling drive mechanism may be located on a quay or other platform, the drive mechanism including means for coupling the power source to the floating reel.

Alternatively, a source of motive power for said spooling drive mechanism may be carried on a frame having its own buoyancy and floating with the reel while permitting the reel to rotate within the frame, the drive mechanism including means for coupling the power source to the floating reel.

The coupling means said drive mechanism may comprise a combination of at least one tension element and at least one bracing element acting at different heights on the reel so as to apply torque while holding the floating reel at a distance from the quayside.

The tension elements may comprise wires wound around a part of the floating reel distinct from a part where the article is wound, such that said wires being unwound from the floating reel onto a winch will cause the floating reel to rotate and wind-on the article.

In a preferred embodiment, a pair of bracing elements and tensioning elements are provided, to act in balance at either side of the floating reel.

In embodiments with a frame, the bracing elements may comprise limbs of the frame. The bracing elements may act at a hub of the floating reel, via bearings.

The reel may be dimensioned so as to provide at its widest point an incremental buoyancy in excess of 250×10³ kg per metre of immersion, preferably in excess of 300×10³ kg per metre.

The apparatus may further comprise couplings provided on the frame and complementary couplings on a structure such as a quay and/or vessel, for mooring the frame and reel combination using mechanical couplings.

The mechanical couplings may include a movable part permitting the frame to adjust its height relative to the structure. The movable part may be a hinged arm, for example.

The apparatus may comprise a plurality of floating reels operable independently.

In an embodiment where each reel is provided with a floating frame, two of said frames may be provided with complementary mechanical coupling parts, for rafting them together. The or each frame may be provided with complementary male and female mechanical coupling parts at opposite sides thereof. The couplings may be for coupling the reels with their axes parallel and spaced such that an article unwinding from one reel will pass over or under the other reel.

In an embodiment where the reel is provided with a floating frame, the frame and reel may be coupled by bearings at the axis of rotation. These may be alternative to or additional to bearings on a rim of the reel. The invention still avoids the very costly bearings of the known reel-to-reel transfer proposal, because the bearings need only carry marginal weight and possibly forces generated by the drive mechanisms and tension in the article, which are generally an order of magnitude smaller than the weight of the load and reel out of water.

The frame may comprise a generally rectangular structure having at least three sides, when viewed from above, having at one end a cross-beam structure extending generally parallel to the axis of the reel and outside a winding surface of the reel, and a pair of arms extending generally parallel to a radius of the reel toward the axis of rotation along at two sides of the reel. (‘Side’ in this context refers to the end faces of the reel, in the axial direction.) The rectangular structure may be effectively four-sided, if preferred.

The drive mechanism for spooling and/or transfer may include means for transferring radial forces to the reel via said arms.

Alternatively or in addition, the drive mechanism for spooling and/or transfer may include bracing elements acting between points on said cross-beam structure and circumferential surfaces on said reel.

The frame, if it has buoyancy at an extended radial distance outside the radius of the floating reel, allows drive and control apparatus to be carried and moved from place to place as part of a self-contained floating reel & frame assembly, without the expense of providing a complete barge for supporting the laden reel fully out of the above the water.

The frame, in a case where it has buoyancy at an extended axial distance outside the length of the floating reel, can provide stability against rolling of the reel.

While the transfer operation can be conducted in the sheltered waters at a shorebase, the transfer apparatus may be improved to cope with larger relative movements of both reel and vessel, and the floating reel designed for transoceanic tow. The invention in such an embodiment enables the loading of a reel lay vessel in its field of operation, that is without the need for transit to an onshore base, yet without any need to lift a loaded reel, nor to support it on mechanical bearings.

The invention in its various forms may be adapted for storage and transfer of any elongate article besides pipeline, for example cables.

### BRIEF DESCRIPTION OF THE DRAWINGS

Embodiments of the invention will now be described, by way of example only, by reference to the accompanying drawings, in which:

FIG. 1 illustrates the performance of a spooling step of a method embodying the present invention (a) from above and (b) from one side;

FIG. 2 is a side view of the transferring step of a method embodying the invention;

FIG. 3 illustrates by a schematic plan view (a) beginning, (b) middle and (c) end conditions in the performance of the spooling step;

FIG. 4 illustrates by a schematic plan view the performance of the spooling step at a shore base, simultaneously with pipe laying operations by a pipe laying vessel at a working location remote from the shore base;

FIG. 5 illustrates performance of the transferring step with the vessel returned to the shorebase;

FIG. 6 illustrates performance of the transferring step in a second embodiment of the invention;

FIG. 7 illustrates performance of the transferring step in a third embodiment of the invention;

FIG. 8 comprises pie charts illustrating the increased productivity of the vessel in different embodiments of the invention, compared with a conventional spoolbase;

FIG. 9 illustrates the beginning of a spooling step in a fourth embodiment of the invention;

FIG. 10 illustrates the rafting of two laden reels in the fourth embodiment of the invention;

FIG. 11 illustrates performance of the transferring step in the fourth embodiment of the invention; and

FIG. 12 is a schematic plan view of an onshore facility suitable for use in the methods of the invention.

### DETAILED DESCRIPTION OF THE EMBODIMENTS

Embodiments of the invention will be described primarily with reference to the laying of rigid pipeline, and later with reference to flexible pipelines. As mentioned in the introduction, the principles of the invention are applicable to these and other types of very long article, including for example cables and umbilical assemblies in which various pipes and cables are bundled together.

In a conventional reelbase, continuous steel pipeline is fabricated in straight sections or stalks of about 600 m to 1800 m (these in turn are fabricated from shorter sections or ‘joints’ of pipe, but that is not material to the present description). A conventional reel lay vessel is loaded with the pipeline by reeling on one stalk, performing the joint between the loaded stalk and the next stalk, resuming reeling and repeating these steps until the full load is achieved. The rigid steel pipe is subjected to plastic bending in this process, and straightened again as part of the laying operation at sea. During spooling, the pipelay vessel is not productive. The lengthy operation isn't the spooling in itself but the joining operations, which can take up to 6 hours per joint. Therefore, the available straight length onshore is an important factor that will further decide of the efficiency of any given combination of reel-lay vessel and spoolbase. Increasing the straight length assembled onshore may not be possible, or at least adds to the cost and scarcity of suitable spoolbases. If suitable spoolbases are few and far between, any efficiency gain is lost in increased transit times between the spoolbase and the lay site.

To improve efficiency, there have been proposed reel-to-reel transfer methods, whereby the pipeline is first wound around supplementary reels, either onshore or mounted on cargo barges. By doing so, all intermediate connections or ‘tie-ins’ are realised before loading the reel ship, and hence without delaying it. Reel-to-reel transfer isn't considered to degrade the pipeline, provided that no supplementary plastic deformation is induced compared to the original single reeling and straightening cycle. In transfer between the two reels, the pipeline is not straightened but simply elastically guided from one reel to the other. However, if they are to carry a full load of several thousand tonnes, the supplementary reels incur a high capital cost, particularly because of the mechanical bearings required to support them. If the load of each supplementary reel is reduced, then not only must their number increase, but the delaying step of tie-in operations becomes significant again.

The following description and drawings illustrate a new approach which is believed to enhance the economics of the reel-to-reel transfer, by using a self-supported floating reel, which will not require any structure able to carry its load nor bearings. The pipeline is wound from a jetty around the floating reel before the vessel comes in. When the vessel comes in, the reel can optionally be towed to the vessel alongside a quay and the reel-to-reel transfer may commence. With such arrangement it becomes possible to load pipeline simultaneously with vessel's loading alongside any quay, or even offshore.

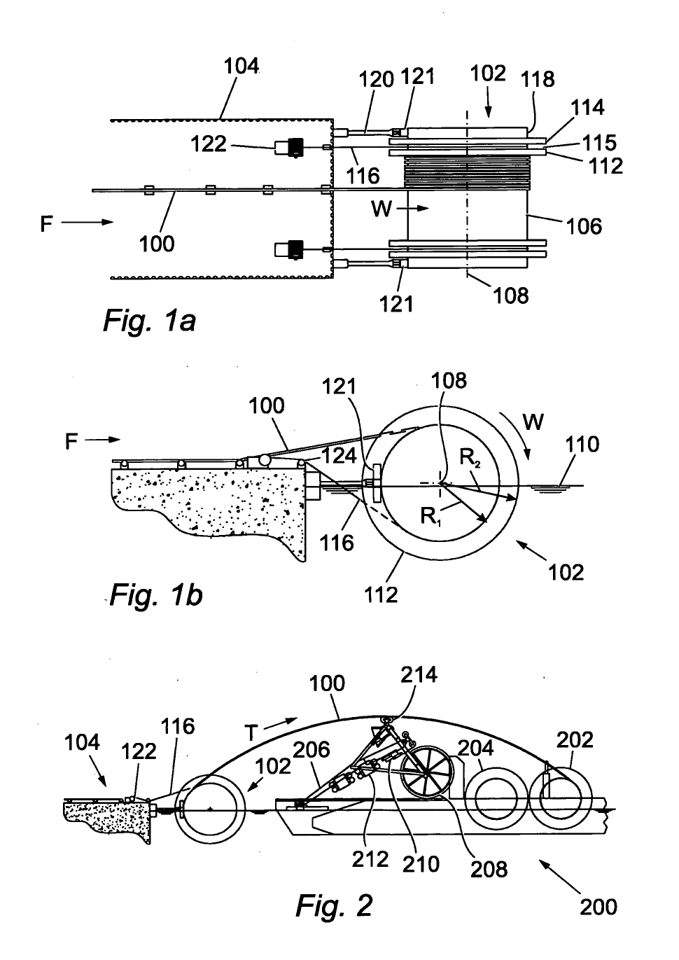

FIG. 1 (a) and (b) illustrate a spooling operation in which continuous welded pipeline 100 is wound on to a floating reel 102 alongside a quay 104. Arrow F indicates the direction of fabrication of the pipeline from a tie-in station (not shown). Arrow W shows the direction of winding of the pipeline on to a main section 106 of the floating reel. It can be seen from the top view (a) and side view (b) that the reel is a generally cylindrical drum, floating with its axis 108 substantially horizontal, parallel to the quayside and, in this embodiment, slightly above the level of the water. In one example embodiment, the radius R₁ of the main section 106 is approximately 11 meters, and its axial length 16 meters. Outside the main winding section 106, in each direction along the axis, the reel is provided with a first flange 112 for restraining the pipeline 100 when wound on the drum, and a second flange 114 spaced from flange 112 so as to define an auxiliary winding region 115 for a drive wire 116, to be described later. Since the arrangement is symmetrical at the two ends of the drum, only one set of these components is labelled in the diagram, to reduce clutter.

The radius R₂ of the flanges 112, 114 may be 14.5 meters, for example, allowing a maximum depth of 3.5 meters for wound pipeline. The length of pipeline that can be wound into such a space will depend naturally on the diameter of the pipe itself: the same reel can accommodate more turns of a narrower pipe. The total weight of pipe may be in the region of 2000 to 3000 metric tonnes, compatible with the largest reels mounted on modern lay vessels.

At the axial extremities of the reel 102, bearing surfaces 118 are provided. In the illustration, it will be noted that the radius of the main drum section, the intermediate section between flanges 112 and 114 and the bearing surface 118 are all shown as equal, for example 11 meters radius. This is a convenient construction, but there is no reason why the radii of these different sections and the radii of the flanges 112 and 114 should not be varied according to their different functions and design criteria. Similarly, in other embodiments, the auxiliary section for winding the drive wire 116 may be provided at a more extreme axial position that the bearing surfaces 118. The arrangement shown is believed convenient, however. The overall length of the reel may be 26 or 27 meters.

Between the quay 104 and the reel 102 are a pair of bracing devices which will be referred to as reel stops 120. These comprise rigid arms fixed at one end to the quayside with some allowance for up and down pivotal motion, and provided at the other end with bearings 121 for engaging the bearing surfaces 118 of the reel 102. These arms, whose length may be comparable to the radius of the reel, maintain the reel 102 at a fixed distance from the quayside, countering tension in the pipeline 100 and the drive wires 116.

The bearings 121 at the end of each reel stop 120 may include rollers or the like, permitting the bearing surface 118 to move freely past the reel stop end, so that the entire floating reel 102 can rotate about its axis 108, for winding and/or unwinding of pipeline 100. The aim should be to remain mechanically as simple as possible to guarantee low maintenance, limited requirement for spare parts and easy repair in remote areas. In practice, therefore, the bearings might be of simpler construction, for example steel against wood or PTFE, depending design criteria. Water will permanently lubricate those bearings, so that rollers may be unnecessary.

Torque for causing the winding rotation W is provided through the drive wires 116 by winches 122 mounted on the quayside. Assuming, for ease of explanation, that the drive wires 116 and the pipeline 100 are both applied to the reel at the same radius R₁, simple physics confirms that, to start and stop winding the pipeline in a controlled fashion onto the reel section 106, it is only necessary to control the tension in the drive wire 116 to be sufficiently greater than the tension in the pipeline. Relaxing tension in the drive wires allows the winding operation to be stopped. In order that the tension in the drive wire 116 operates in opposition to the tension in the pipe line 100, when both are being pulled to the same side of the floating reel, the pipeline extends to the top side of the reel, while the drive wire 116 is diverted to the underside over a sheave 124.

The skilled person will appreciate that a certain degree of tension should be maintained throughout the winding operation, even when stopped, to prevent the highly elastic steel pipeline from unwinding in an uncontrolled fashion. A significant back-tension is therefore maintained on the pipeline 100, for example by caterpillar-type track tensioners or linear winches, not shown. Simple physics further confirms that the sum of the tension in the drive wires 116 and the pipeline 100 will be applied as a compressive force on the bearing ends of the wheel stops 120. These forces may be measured in tens or hundreds of tonnes, but it will be noted that the bearings are not required to support the weight of the pipeline wound on to the reel 102, which would be measured in thousands of tonnes and would require far more expensive bearings. This is because the weight of the reel itself, and any pipeline wound on to it, is accommodated in this embodiment entirely by buoyancy within the reel 102 itself, supplemented optionally by additional elements (not shown) attached to the reel if desired. With the dimensions of 11 m radius and 26 m length given above as examples, and assuming for simplicity that the entire space within the drum is filled with air, a total air space of Pi×11²×26=9884 m³ can be calculated, providing nearly 10000 tonnes of buoyancy to support the drum and its load of pipe.

The buoyancy of the reel and such additional elements, if any, could be adjusted before, after or during the reeling and unreeling operations, if it should be important to maintain the axis 108 at a specific level in relation to the water line 110. This might be more important where the reel is to be towed in open seas, but may not be necessary if all operations are performed in sheltered harbour waters.

At the conclusion of the spooling operation illustrated in FIG. 1, it will be understood that the reel 102 is filled with a requisite load of continuous pipeline, all of this achieved without the presence of the lay vessel.

FIG. 2 illustrates the transferring step, performed when a lay vessel 200 approaches the reel 102, which remains positioned between the vessel and the quay 104. Vessel 200 is equipped with a pair of pipe storage reels 202 and 204 and pipe laying apparatus mounted on a tiltable tower 206 at the stern of the vessel. The pipe laying apparatus 206 is relatively conventional and will be described only briefly. At the top of the tower is a radius controlling wheel or diverter 208, which is not in play when the tower 206 is inclined as shown, but guides the pipeline from one of the reels 202/204 to the top of the tower, during laying operations. Following the path of the pipeline down the length of the tower from the diverter 208, we find a straightener 210 and one or more tensioners 212 of caterpillar track type. These control the paying out of the pipeline over the stem of the vessel when operating at sea. The reels 202 and 204 are provided with mechanical bearings to support the weight of the stored pipeline, and also with drive arrangements for providing back tension during laying, and also for providing the torque to reel on the pipeline during the transferring step illustrated in FIG. 2.

In the transferring step illustrated in FIG. 2, the reel 102, loaded with pipeline in the spooling step of FIG. 1, has been decoupled from the quayside and reorientated end-for-end, so that the pipeline which wound onto the reel from the left hand side as shown, can now be unwound from the reel towards the right hand side, following the direction of transfer arrow T, in a catenary curve, all the way to the reel 202 on the vessel. The drive wire 116 provides a controlled degree of torque to maintain exactly the required degree of tension in the pipeline 100 during this step. Now that the pipeline and drive wire are extending in opposite directions (left and right as shown), the drive wire and pipeline both meet the reel 102 at its upper side.

In order to support and stabilise the pipeline 100 as it spans in its plastically bent condition from the floating reel 102 to the storage reel 202 on the vessel, a set of guide 214, which may be referred to as a “fleeting” is provided on an extension of the tower 206. The guide 214 may be permanently attached to the tower 206, or maybe fitted only for the transferring operation, and removed before vessel 200 returns to sea for laying operations. Examples of the guide arrangements and control systems appropriate to control reel-to-reel transfer of welded steel pipe are described in more detail in WO 98/15763, mentioned above.

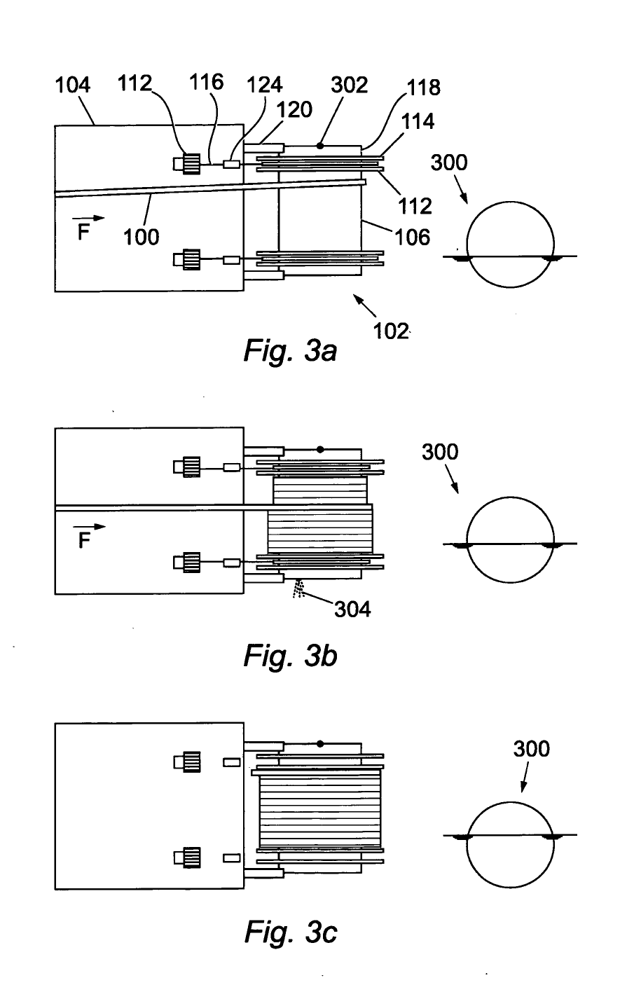

FIG. 3 shows schematically the spooling process of FIG. 1, as it progresses from an initiation phase (a) through a middle phase (b) to a completed phase (c). Reference signs the same as those used in FIGS. 1 and 2 are reproduced on FIG. 3 (a), but not repeated on FIGS. 3 (b) and (c) to reduce clutter.

In the initial condition FIG. 3 (a), the reel 102 is empty of pipeline, but the first end of pipeline 100, travelling in the fabrication direction F, has been led by a cable to begin winding around the main section 106 of the floating reel. The section 115 of the reel between flanges 112 and 114, on the other hand, has a full load of drive wire 116, wound in the opposite direction to the direction in which the pipeline will be wound, and extending up through sheave 124 and onto the drive winch 122. As explained already in relation to FIG. 1, the winch 122 and tensioners acting on the pipeline 100 are maintained in operation, so that the pipeline 100 is never in a relaxed state, but always maintained in tension on a desired line, and bent around the reel 102. As mentioned previously, the floating reel 102 is reversed end-for-end prior to the transferring step. To aid identification through the drawings which follow, a spot 302 has been added at one end of the floating reel 102. As the reel is relatively unladen, it floats high in the water at this stage, as indicated by the water level 300 in the schematic end view shown at the right hand side of the drawing.

Referring now to FIG. 3 (b) the winding operation is underway, with one or more layers of pipeline now present on the main section 106 of the reel 102. The stock of drive wire in section 115 is somewhat depleted, as it has been drawn onto winch 122, by a length corresponding roughly to the length of pipeline now wound onto the reel. The water level indicator 300 beside the drawing shows that the reel has sunk to a lower level against the water line 300. In this way the buoyancy of space (air) within the sunken part of the reel compensates the increased weight of pipeline 100 now carried on the reel.

With the dimensions of 11 m radius and 26 m length given above as examples, and assuming again that the entire space within the drum is filled with air, the drum at is widest point comprises an incremental buoyancy of 22×26=576 tonnes per metre depth, to support the drum and its load of pipe.

Finally, in FIG. 3 (c) we see the reel 102 in its fully-laden state, and floating at its lowest level in the water, as shown by the indicator 300 to the right hand side. The drive wires 116 have been disconnected from the reel, permitting it to be removed from this part of the quayside, if desired, and permitting it to be re-oriented for a transfer operation.

As mentioned previously, the floating reel is provided with integral buoyancy, in the form of various internal compartments, not seen in the drawings. At least some of these compartments can be made operable as ballast tanks, in order that the overall buoyancy of the reel, and also its trim (balance) may be adjusted. As an option, in order to reduce the variation in the level of the reel in the water as the load varies, pumps may be operated to expel ballast water during loading itself, as shown at 304. Relatively complex arrangements would be required to permit pumping during rotation. Simpler arrangements could be made to adjust the ballast after the winding or unwinding is complete, for example prior to an ocean transit. In practice a reel of

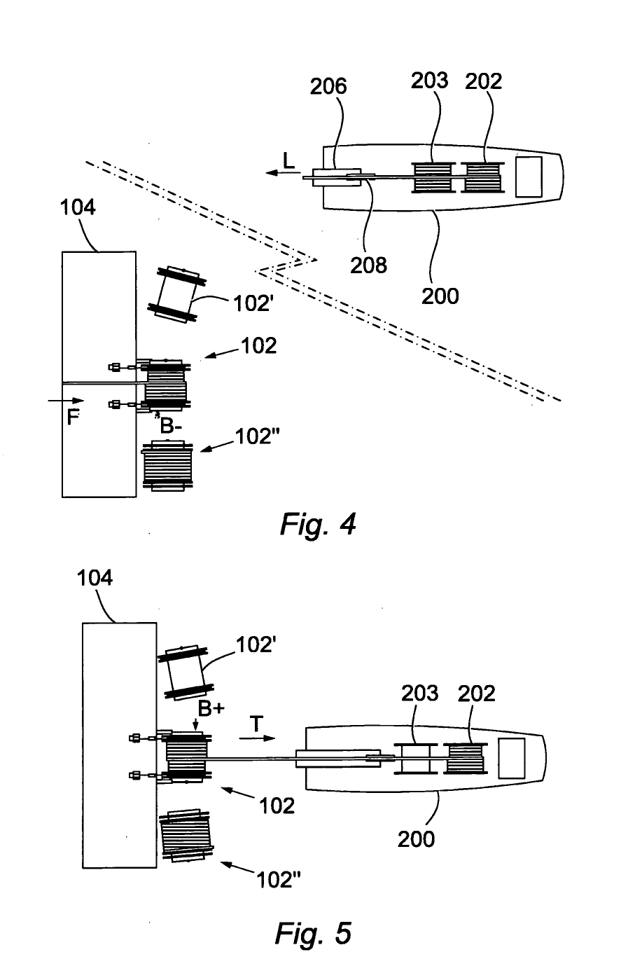

Having described the basic structure of the floating reel and adapted spoolbase, the use of the floating reel in a complete pipe lay operation will now be described by reference to various examples, some of which are illustrated in FIGS. 4 to 7.

FIG. 4 illustrates at top right the lay vessel 200 having the pipe lay apparatus mounted on tower 206 at its stern end. The forward storage reel 202 is in use, with its stock of pipeline 100 being unwound via the diverter 208, tensioners and so on, to be laid along the path indicated by arrow L to the seabed. The aft storage wheel 203 is fully laden with pipeline, ready to be used when reel 202 is depleted. It is assumed for the present descriptions that reels 202 and 203 contain similar pipeline in discrete batches, for laying and connecting end-to-end. It is of course perfectly possible that two different types of pipeline are stored on these reels, for laying side-by-side or at different locations. Different pipes may even be wound onto one reel, provided the one wound on last is the first to be laid.

The lay operations are typically conducted hundreds or thousands of kilometres from the spoolbase. In parallel with the laying operation by vessel 200, a number of floating reels 102 are being processed at the spoolbase including quay 104. In the example situation shown, a reel 102 is being wound with a load of pipe progressing along fabrication axis F, while a spare reel 102′ floats empty nearby. A third reel 102″ is fully laden with pipeline, and again floating somewhere alongside the quay. It goes without saying that the reels 102 etc. are fully provided with attachment points for tow lines and mooring lines, which will not be discussed or shown in any detail. Similarly, various tugs and other working vessels will also be in attendance, and used in various stages in the procedure.

As shown in FIG. 5, at some point the lay vessel 200 will run out of its stored pipeline, and return to the spoolbase for re-stocking of the reels 202 and 203. By this time, two complete loads of pipeline are already fabricated and stored on the floating reels 102 and 102″. At the stage of operations illustrated, the vessel 200 has aligned itself with the first reel 102, which has previously been reoriented. Approximately half of the pipeline 100 has already been transferred to the forward reel 202, while ballast water is being added to maintain the reel 102 floating at a constant height, as indicated by ballast intake arrow B. Once the transfer of pipeline from reel 102 to reel 202 is complete, reel 102 can be moved aside and reel 102″ put in its place, for transfer to the second storage wheel 203.

It will be appreciated that the method described permits continuous spooling of pipeline onto the storage reels of the pipe lay vessel 200, without any delay for tie-in operations. Naturally, if the floating reel 102 does not accommodate sufficient pipeline to fill the storage reel 202, a tie-in operation between smaller quantities of pre-fabricated pipeline may still be provided. However, the floating construction of the reel permits a very high capacity reel to be constructed economically, so that it should be possible to attain the full potential efficiency without the capital expenditure associated with the known reel-to-reel solutions.

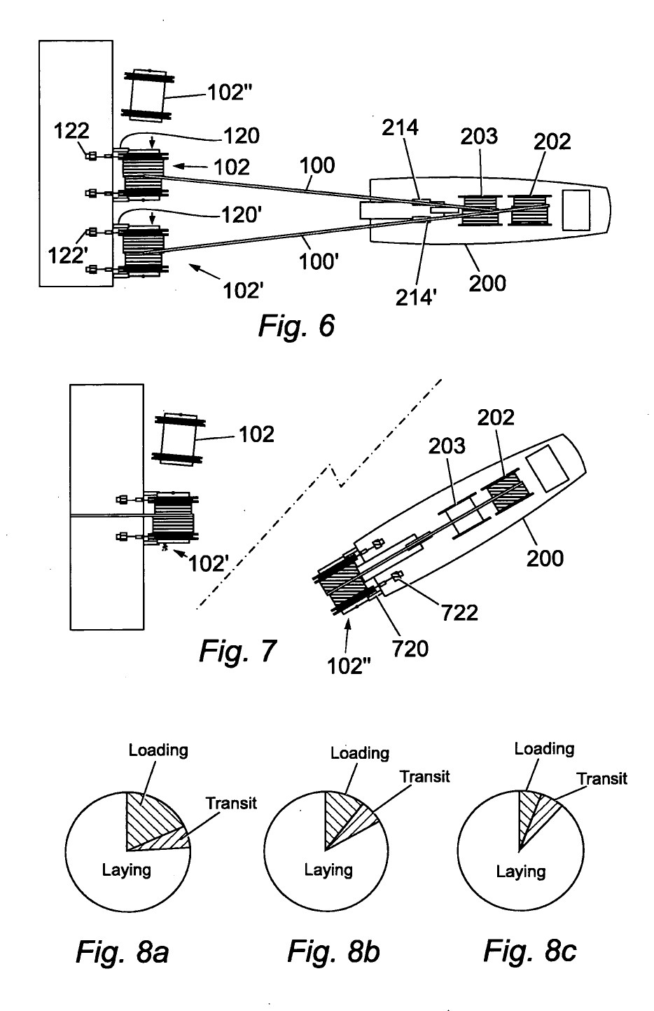

FIG. 6 illustrates an even more productive arrangement, in which not only the number of floating reels 102 but also the number of reel stops 120 and drive winches 122 is multiplied to at least match the number of storage reels 202, 203 on the vessel 200. The additional reel stop and drive winch are labelled 120′ and 122′, and are shown with laden reel 102′ associated with them. The vessel 200 is also provided with two guides 214 and 214′. As a result, a pair of prefabricated pipelines 100 and 100′ can simultaneously be transferred from the two floating reels 102, 102′ to the two storage reels 202, 203 on the vessel.

FIG. 7 illustrates a further possibility, in which a fully laden reel 102″ has been moved to a completely different location from the spooling location, where for example another reel 102′ is being loaded with more pipeline. The vessel in this example is provided with winches 722 and reel stops 720 corresponding to elements 120 and 122 of the spool case shown in FIG. 1, so that it may perform the transfer operation in a substantially independent fashion. The transfer operation may, for example, be performed alongside a quay separate from the spoolbase, while other servicing and re-stocking operations are preformed on the vessel, further improving efficiency.

Provided that the floating reels 102 etc. are constructed for ocean transit, and the reel stops and drive arrangements are adapted to cope with the somewhat larger relative movement that might occur in rougher waters, it is further possible that the whole transfer step can be performed at the offshore laying site, or at least at some intermediate location. This means it may be possible to eliminate even the transit time required to implement the transfer method illustrated in FIG. 5. With this facility, particularly where three or more floating reels are provided, a continuous shuttle of pipeline stock can be maintained between the spoolbase and the vessel, meeting the vessel either at the lay site or at some convenient intermediate location other than the spoolbase.

The pie charts of FIG. 8 compare the efficiency of utilisation of the lay ship in various different schemes enabled by the floating reel described above. In each chart (a) to (c) there are shown three segments of time, namely the time spent laying (productive time), time spent in transit (assuming a typical distance between the lay site and the spoolbase) and the time spent loading the pipeline (transfer step). Chart (a) represents the proportions of time spent in these various activities in a conventional vessel and spoolbase. The vessel spends just over three quarters of its time in productive laying operations, but nearly a fifth of its time simply loading pipeline. Chart (b) illustrates the performance possible using reel-to-reel transfer with the same vessel, and a spoolbase equipped with just one floating reel of the type described above, loading successively each of two reels on the vessel. Immediately, the proportion of the vessel's time spent loading has been reduced to approximately 10 percent, giving a corresponding increase in the percentage of time spent in productive laying activities. Finally, FIG. 8 (c) illustrates the potential efficiency of providing two floating reels and simultaneously transferring pipeline onto the two storage reels of the vessel, as shown in FIG. 6. The loading time is reduced to approximately 5 percent of the total, and the productive laying time is almost 90 percent of total. Further improvements would be attained by eliminating transit time, by the measures illustrated in FIG. 7.

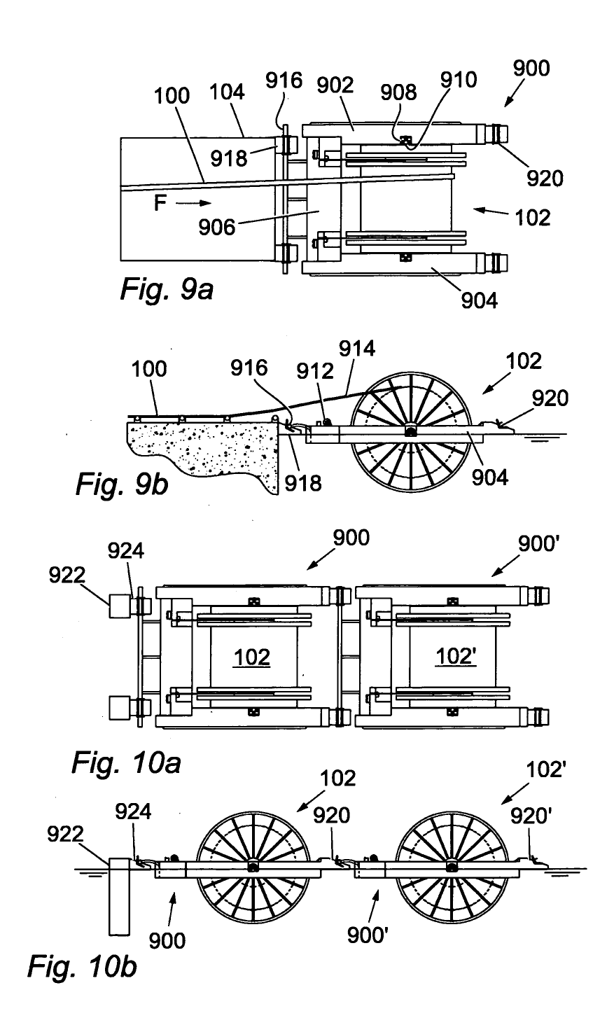

FIG. 9 shows in plan view (a) and side view (b) the spooling step being performed in a further example, in which the floating reel 102 is surrounded on three sides by a floating frame 900. The frame is generally C-shaped, comprising first and second arms 902, 904 running parallel to respective end faces of the floating reel, and a cross-beam 906 joining the arms into a rigid C-shaped structure. Each arm carries a bearing socket 908 which receives an axle 910 projecting from the end face of the reel 102. Cross-beam 906 carries two drive winches 912 which pull on the drive wires 914, similar to the drive winches and wires 122 and 124 of the earlier examples. Reel stops 120 used in the earlier examples are no longer required, nor are the corresponding bearing surfaces 118 on the drum, as the counter-force to the winch and pipe tension is transmitted to the reel through frame 900, bearings 908 and axles 910. The arms and cross-beam are preferably made hollow to provide the frame with its own buoyancy, and buoyancy sufficient to give extra support to the reel in its more laden states. The buoyancy of the frame contributes to the stability of the assembly, as well as its overall buoyancy. The total buoyancy of the frame may be in the range 200-500 tonnes, for example, that is several times less than the buoyancy of the floating reel.

A coupling arm 916 is hinged to the frame at several points along the cross-beam 906, and can be engaged with mating receptacles 918 provided on the quay 304. Because the coupling arm is hinged relative to the frame, it can accommodate the frame floating at different levels in the water. The frame itself can tilt to an extent also, so that the distal ends of arms 902, 904 are submerged to a greater degree than the cross-beam 906. Receptacles 918 are provided with a locking mechanism, not shown in detail, to avoid accidental decoupling of the frame from the quay.

Similar mating receptacles 920 are provided on the opposite ends of the arms 902, 904, to allow two such frames 900, 900′ to be coupled together in a form of raft, as illustrated in FIG. 10. FIG. 10 also illustrates the provision of mooring piles 922 with further mating receptacles 924, allowing the reels with frames to be moored at a storage location away from the quay 304. Each coupling hinges as mentioned above. Although they are illustrated lying horizontally, parallel to the waterline, in practice the frames 900, 900′ may tilt fore-and-aft, according to the balance between its own buoyancy and that of the reel.

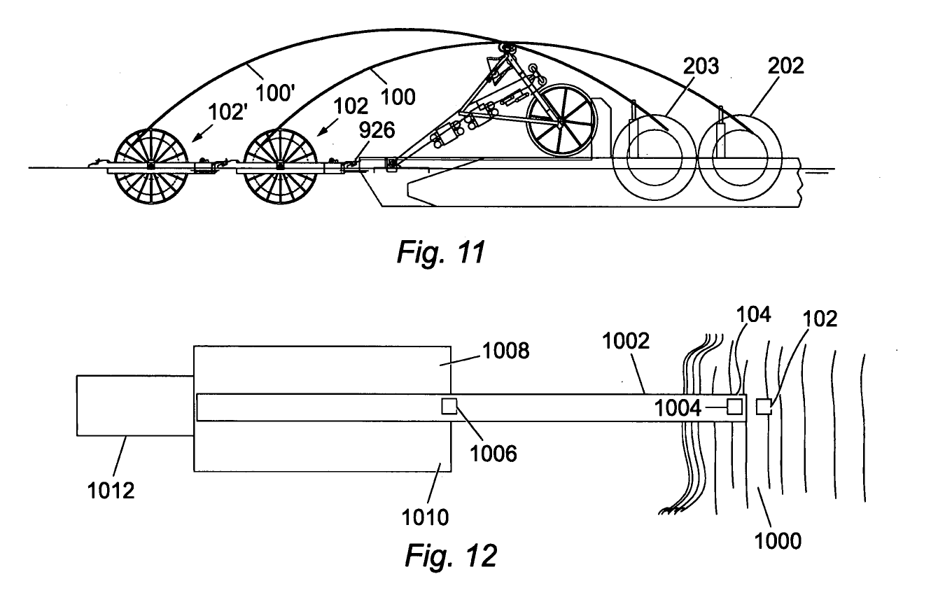

FIG. 11 illustrates the transferring step in this fourth example, in which a pair of reel/frame assemblies 102/900 and 102′/900′ have been towed to the location of pipelaying vessel 200. The vessel in this example is equipped with receptacles 926 to receive the coupling bar 916 of the first frame 900. Pipelines 100 and 100′ are being transferred simultaneously to the reels 202 and 203 of the vessel, respectively. Note that each frame carries the drive mechanism for its reel, so that winches or equivalent drives are not required to be permanently mounted to the quay or the vessel: they travel with each reel, ready for use. Note also that the two reels are in line for the parallel transfer operation, which may be more convenient than the side-by-side arrangement of FIG. 6. If side-by-side is preferred, arrangements can be made to raft the frames side-by-side accordingly. As in the previous examples, the use of reel buoyancy to support the load removes the need for very high capacity bearings, which limit known reel-to-reel systems. Although axles and bearings are provided in this example, they are only required to bear a few hundred tonnes for drive and stability purposes. Bearings of thousands of tonnes capacity would be needed to support the full weight of the reels and their pipeline load.

Finally, FIG. 12 illustrates schematically the layout of a spoolbase which may be provided on shore for spooling pipeline onto the floating reels, in whichever of the above examples may be chosen. The spoolbase is a facility on shore, beside the water 1000 of a suitably sheltered harbour. Quay 304 and reel 102 are shown schematically, the quay being at the end of a long working ramp 1002. The working ramp is provided with two stalk joining stations 1004 and 1006, spaced apart by a half-stalk length, for example 450m. Either side of an upstream half of the ramp 1002, two storage areas 1008, 1010 are provided of length 450 m or so, or storage of many pre-fabricated half-stalks of that length. At the upstream end of the ramp, a stalk factory 1012 is arranged to join shorter sections of pipe into half-stalks.

In operation, as a preliminary step, half stalks of 450 m or so are fabricated in the factory 1012, fed out onto the upstream section of the ramp and translated one by one into the storage areas 1008, 1010. All of this can be done irrespective whether the reels and vessel are present. Subsequently, for the spooling onto the reel 102, two of these half stalks are retrieved and fed along the ramp, to be joined together at joining station 1004 and joined to the spooled pipeline at joining station 1006. This process is repeated until the reel 102 is fully laden, and then continued with a second and subsequent reel 102′ etc.

Numerous further variations and modifications on the apparatus and processes described above can be envisaged, all within the spirit and scope of the present invention. Examples illustrated provide for winding torque to be applied to the floating reel by braces and drive wires both acting from the same side of the reel, and both acting from a quayside or vessel. Alternative drive arrangements can be envisaged, where the brace and/or drive winches are located on opposite sides of the reel, and/or are located on floating structures such as pontoons or barges. Torque may be applied to the floating reel by means of rack and pinion or hydraulic ratchet arrangements, as an alternative to the drive wire and winches shown, or the wire or chain loop. Reaction for the application of this torque may be provided by quaysides or barges as mentioned, but also by outriggers or the like, floating with the reel. The drive means may even be made quite different between the spooling and transferring steps.

All buoyancy and ballast arrangements in the embodiments described are contained integrally within the floating reel 102, but it is also possible to envisage modular (“bolt on”) buoyancy and/or ballast. Such additional buoyancy or ballast modules may be added and removed progressively during winding and unwinding. Alternatively, they may be used only to adjust the basic level of buoyancy of the reel to suit different types of load, with water ballast being used to make adjustments during the winding and unwinding operations.

None of these variations detracts from the basic principle and advantage of the floating reel, namely that it can accommodate a very great weight of pipeline, comparable to the greatest loads carryable by the largest modern lay ships, without requiring a comparable investment in the structure of the reel and its bearings, as would be required if it were located on a quay side or dedicated reel barge. As will be apparent from the introduction and discussion above, application of this principle to whatever degree enables great benefits in the reductions of capital expenditure on equipment and land for spoolbases, while affording a significant increase in the efficiency of the reel lay vessel.

1. A method of transferring a very long article to a laying vessel, the laying vessel having apparatus for lowering such articles into the sea in a controlled manner, the method including a first step of spooling said article from a source facility onto an intermediate storage reel separate from the laying vessel, and a second step of transferring the article from the intermediate reel to storage on the laying vessel, the storage on the vessel being for presenting said article to said lowering apparatus during a laying step subsequent to the transferring step, wherein the intermediate reel is supported primarily by its own buoyancy in water, floating adjacent the source facility during said spooling step and floating adjacent the laying vessel during said transferring step.

2. A method according to claim 1, in which the article comprises a length of rigid pipeline, the storage on the vessel comprising a reel.

3. A method according to claim 1, in which the article comprises flexible pipeline or other flexible article such as cable or umbilical cable.

4. A method according to claim 3, in which the storage on the vessel comprises a hold space into which the elongate article is coiled during transfer.

5. A method according to claim 4, in which said hold space includes a receptacle to rotate as the article is transferred from said intermediate reel into said coil.

6. A method of transferring a length of pipeline from a storage area on land to a storage reel on a pipe-laying vessel, the method including a first step of spooling a length of pipeline from a source facility onto an intermediate storage reel separate from the vessel, and a second step of transferring the pipeline from the intermediate reel to the reel on the vessel, wherein the intermediate reel is supported primarily by its own buoyancy in water, floating adjacent the source facility during said spooling step and floating adjacent the vessel during said transferring step.

7. A method according to claim 6, in which the spooling step is performed without the laying vessel being present.

8. A method according to claim 7 including a step of moving the floating reel in its laden state between said spooling and transferring steps.

9. A method according to claim 9, in which said moving step comprises re-orienting the reel for transfer to the vessel, while occupying substantially the same position in the water.

10. A method according to claim 6, in which the moving step includes translating the floating reel bodily to a different location for said transferring step.

11. A method according to claim 7, in which the moving step includes towing the floating reel in open sea to the location of the laying vessel.

12. A method according to claim, in which said spooling step includes applying a torque via a spooling drive mechanism so as to turn the floating reef and control the spooling on of said pipeline.

13. A method according to claim, in which the spooling step includes removing ballast from the floating reel so as to compensate at least partially for the weight of article carried on the reel.

14. A method according to claim, in which said transferring step includes applying a torque via a transfer drive mechanism so as to maintain a predetermined back-tension in the pipeline between the floating reel and vessel, while drawing the article onto the vessel.

15. A method according to claim, in which transferring step includes adding ballast to the floating reel so as to compensate at least partially for the decrease in the weight of pipeline carried on the reel.

16. A method according to claim, in which the path of the pipeline in said transferring step is controlled via a device able to guarantee a constant tension within the pipeline all along the transfer as well as correct geometry despite potential relative movements of vessel or jetty and floating reel.

17. A method according to claim, in which there are at least as many floating storage reel as reels on the reel ship.

18. Apparatus for use in transferring a very long article such as pre-fabricated pipeline to a laying vessel, the apparatus comprising:
a reel for receiving said article from a source facility and storing it prior to transfer to a vessel, the reel having integral buoyancy sufficient to support itself for rotation about an axis by floating while winding on and subsequently unwinding a load; and
a frame having its own buoyancy, the frame being adapted to float with the reel while permitting the reel to rotate within the frame.

19. Apparatus according to claim 18, in which the reel is adapted for floating with said axis substantially horizontal.

20. Apparatus according to claim 18, in which the reel is provided with adjustable buoyancy so as to counter the weight of different quantities of stored pipe during winding or unwinding.

21. Apparatus according to claim 20, in which the adjustable buoyancy comprises ballast tanks with inlets for receiving a quantity of water as ballast to reduce buoyancy, the apparatus including one or more pumps for removing said water progressively to increase buoyancy.

22. Apparatus according to claim 18, the apparatus being adapted for transoceanic tow and profiled to limit drag and increase transit speed.

23. Apparatus according to claim 22, in which the floating reel is provided with non-planar end surfaces to facilitate passage through the water in an axial direction.

24. Apparatus according to claim 18, further comprising a drive mechanism for applying torque to the reel to cause winding and/or to control unwinding of the stored article.

25. Apparatus according to claim 24 in which a source of motive power for said drive mechanism for use in spooling is located on a quay or other platform, the drive mechanism including means for coupling the power source to the floating reel.

26. Apparatus according to claim 24, in which a source of motive power for said drive mechanism is carried on a frame having its own buoyancy and floating with the reel while permitting the reel to rotate within the frame, the drive mechanism including means for coupling the power source to the floating reel.

27. Apparatus according to claim 25, in which said coupling means comprises a combination of at least one tension element and at least one bracing element acting at different heights on the reel so as to apply torque while holding the floating reel at a distance from the quayside.

28. Apparatus according to claim 27, in which the tension elements comprise tendons wound around a part of the floating reel distinct from a part where the article is wound.

29. Apparatus according to claim 28, in which said tendon is arranged to be unwound from the floating reel onto a winch to cause the floating reel to rotate and wind-on the article.

30. Apparatus according to claim 28, in which the tendon forms part of an 10 endless loop driven to cause the floating reel to rotate and wind-on the article.

31. Apparatus according to claim 27, in which a pair of bracing elements and tensioning elements are provided, to act in balance at either side of the floating reel.

32. Apparatus according to claim 30, in which the bracing elements comprise limbs of the frame.

33. Apparatus according to claim 32, in which the bracing elements act at a 20 hub of the floating reel, via bearings.

34. Apparatus according to claim 18, in which the reel is dimensioned so as to provide at its widest point an incremental buoyancy in excess of 250×10³ kg per metre of immersion, preferably in excess of 300×10³ kg per metre.

35. Apparatus according to claim 18 further comprising couplings provided on the frame and complementary couplings on a structure such as a quay and/or vessel, for mooring the frame and reel combination using mechanical couplings.

36. Apparatus according to claim 35, in which the mechanical couplings include a movable part permitting the frame to adjust its height relative to the structure.

37. Apparatus according to claim 36, in which the movable part is a hinged arm.

38. Apparatus according to claim 18 comprising a plurality of floating reels operable independently.

39. Apparatus according to claim 38, in which each reel is provided with a floating frame, and two of said frames are provided with complementary mechanical coupling parts, for rafting them together.

40. Apparatus according to claim 39, in which the or each frame is provided with complementary male and female mechanical coupling parts at opposite sides thereof.

41. Apparatus according to claim 40, in which the couplings are arranged to couple the reels with their axes parallel and spaced such that an article unwinding from one reel will pass over or under the other reel.

42. Apparatus according to claim 40, in which the couplings are arranged to couple the reels with their axes aligned.

43. Apparatus according to claim 18, in which the frame and reel are coupled by bearings at the axis of rotation.

44. Apparatus according to one of claim 18 or 24, in which the frame comprises a generally rectangular structure having at least three sides, when viewed from above, having at one end a cross-beam structure extending generally parallel to the axis of the reel and outside a winding surface of the reel, and a pair of arms extending generally parallel to a radius of the reel toward the axis of rotation along at two sides of the reel.

45. Apparatus according to claim 44 when dependent on claim 24, in which the drive mechanism for spooling and/or transfer includes means for transferring radial forces to the reel via said arms.

46. Apparatus according to claim 44 when dependent on claim 24, in which the drive mechanism for spooling and/or transfer includes bracing elements acting between points on said cross-beam structure and circumferential surfaces on said reel.
